(19) United States
(12) Patent Application Publication
(10) Pub. No.: US 2002/0071681 A1
(43) Pub. Date: Jun. 13, 2002

(54) Device and process for processing photographic material

(76) Inventors: Eni Scodellaro, Italy (IT); Ennio Pessot, Italy (IT); Fabrizio Giusti, Italy (IT)

Correspondence Address: Dick, Bronstein, Robert & Cushman, Intellectual Property Patent Practice, EDWARDS & ANGELL, LLP, Biston, MA, 02209, US

(21) Appl. No.: 09/938,264

(22) Filed: Aug. 23, 2001

(30) Foreign Application Priority Data
Aug. 24, 2000 (EP) 00 117 387.1

(51) Int. Cl. G03D 3/00

(52) U.S. Cl. 396/564

(57) ABSTRACT

The invention is directed to a device for processing photographic material, said device comprising at least one low volume processing and transport channel which does not include any transport means, wherein the level of the transport liquid is held within the boarders of the processing and transport channel.

### BACKGROUND OF THE INVENTION

1. Field of the Invention

The present invention relates to a device and a process for processing photographic material. In particular the present invention relates to the processing of photographic films and to a process for processing photographic films.

2. Related Prior Art

Known processors for processing photographic material usually have several problems. First, the processing liquid has to be heated to a particular temperature and because of the large surface area of the heated processing liquid, a significant amount of liquid is evaporated. This causes a considerable loss of processing liquid and an unexpected alteration of the mixture or combination of the different processing liquids. Furthermore, the use of processing liquids is accompanied by the risk that the at least partially dangerous processing liquids can come into contact with an operator of the processor.

To try to overcome these and further disadvantages, a processor with a narrow processing channel has been proposed. The processing channel generally has a U-shaped configuration with an entrance section, a processing section and an exit section, for processing the photographic material. A nozzle is usually arranged in the narrow processing channel for supplying the processing liquid to treat the photographic material. This prior art, however, has the shortcoming that the photographic material conveyed through the narrow processing channel can be damaged, and in particular there is a tendency to jam in the nozzle supplying region. Furthermore, while the processing channel is made narrower, transport roller pairs are nevertheless held under the level of the processing bath, so that the overall volume of the processing bath is still very large.

According to EP 0 878 736 A1, another solution has been proposed, according to which the narrow processing channel is provided with a step for lifting the leading edge of the photographic material from the bottom surface of the processing channel. This measure should help to avoid jamming in the processing channel.

However, this proposal is also not sufficient since, while the processing channel is narrow, all the pairs of transport rollers in the entrance section and the exit section of each of the channels still have to be covered by the processing liquid, as referred to in EP 0 880 072 A1.

Accordingly, this prior art also only discloses a large volume processing vessel, wherein on the one hand the processing channel itself is narrow, while on the other hand the voluminous entrance and exit sections also have to be kept completely under the surface of the processing liquid, e.g. a developer solution, a bleaching solution, a fixing solution or a stabiliser solution. This is necessary due to the possibility that any dirt particles on the transport roller bath could otherwise damage the emulsion side of the photographic material, e.g. photosensitive print paper or photosensitive photographic film.

### SUMMARY OF THE INVENTION

It is an object of the present invention to provide a processing vessel for processing photographic material by means of a small volume processing channel, without the need for regularly covering the transport means for conveying the photographic material with the processing liquid or processing solution.

In addition, it is an object of the invention, to keep the transport means clean and smooth without covering the transport means with the processing liquid.

It is another object of the invention to provide a processing device which as far as possible avoids the evaporation of processing liquid.

It is an object of the invention to provide a new device which is also able to deal with a low level work load, for instance only one film per week without the necessity of withdrawing the processing liquid from the processing and transport channel, i.e. the processing vessel. It is a further object of the invention to modify the liquid part of the photo finishing process so that an operator is no longer confronted with the shortcomings of the wet chemistry portion, i.e., the wet chemistry part is loaded with as little processing liquid as possible, while the processing liquid is kept in a closed loop to avoid pollution of the environment.

In order to achieve the above objects according to one aspect of the present invention a device for processing photographic material, e.g. undeveloped photosensitive film comprises a sequence of consecutive processing vessels, each of said processing vessel having an entrance portion and an exit portion, and at least one of the processing vessels having a low volume processing and transport channel therebetween, said processing and transport channel(s) being connected to a processing liquid replenishment portion and a withdrawal portion, for replenishing and withdrawing said processing liquid, wherein the replenishing portion is arranged near the entrance portion of the processing and transport channel and the withdrawal portion is arranged near the exit portion of the processing and transport channel, so that the level of the processing liquid is held within the processing and transport channel.

In accordance with to the present invention, it is therefore possible to accomplish a genuinely low volume process for processing, e.g. developing, bleaching, fixing and/or stabilising, a photographic material.

This means that it is possible to realise a treatment for photographic material with very low amounts of vapour from evaporated processing liquids, and that the amount of processing liquid which circulates through the processor for photographic material can be kept very low so that the complete process seems to be a dry process or a nearly-by dry process. The low amount of processing liquid and the very small surface area of the corresponding processing bath allows the device in accordance with the present invention to be maintained over a long period of time without being used, and allows very small amounts of photographic material to be processed. For instance, it is possible to process one negative film per week and to maintain the processing liquid in the system of the device according to the invention and to use the same processing bath for hundreds of films just afterwards, and so on. The device in accordance with the invention allows such unequal cycles because the processing liquid only has a very small surface area in contact with the environment and which can react with the ambient air of the environment, such that the composition of the processing liquid can only be affected over very long time periods.

A very low volume processing channel can be used in accordance with the invention because, particularly for undeveloped negative film, the photographic material is transported in the same direction as the processing liquid in a recycling arrangement where the processing liquid is heated such as to be kept at a particular processing temperature. In accordance with the invention a C41 type chemistry is used, for processing and in particular for developing undeveloped negative film, i.e. 135 film and APS film, and the processing temperature has to be raised to be within the range 45° C. to 50° C. at least for the developer bath. The developer bath needs to be kept at a set temperature within a tolerance of ±0.3° C. At about this temperature of 45 to 50° C., it is preferable to develop each area of a photosensitive film for 45 to 50 sec. Accordingly, the film will remain for the same time period in each of the different baths since all other processing and transport channels of the consecutive processing vessels have the same size. Of course, it is possible to use low volume processing and transport channels of different sizes and/or lengths or to use storages for the photographic material between consecutive channels, or processing vessels of different speeds or processing time periods should be necessary if other processing chemistries are to be used. It is also possible to use other processing temperatures and to adjust the remainder of the process to these deviations, keeping however the low volume processing and transport channels.

Since the developer bath is the most critical bath for the photographic material whether it is a photosensitive film or a photosensitive print paper, it is sufficient to control the temperature of the developer bath, and to control all other processing baths depending on the temperature of the developer bath only.

To be able to use a very low volume processing bath, it is advisable to keep any transport means, necessary for transporting the photographic film through the processing baths, out of the processing baths. Accordingly, in contrast to the prior art, the transport means, for instance several pairs of transport rollers, are kept dry during the process. Only the photographic material to be processed can convey processing liquid to the transport means, but only to a very small degree.

The recirculation in accordance with the present invention also includes a recovery portion, in order to be able to withdraw exhausted processing liquid from the cycle. This exhausted liquid is filled into a recovery tank within a cartridge which can also include the fresh processing liquid which is supplied to each of the recirculation cycles to replace exhausted processing liquids.

The processing liquid, and in particular the developer, is directed from the replenishment portion towards an emulsion side of the photographic material, such that the processing liquid has a very close direct contact with the side of the photographic material to be treated. Furthermore, since both the photographic material and the processing liquid are conveyed in the same direction, co-currently with each other, it is possible to avoid turbulences as much as possible, so that the processing reaction, in particular during the development reaction, can be kept equal over the complete surface of the sensitive emulsion side of the photographic material.

For photosensitive film, it turns out that it is also very advantageous if the processing liquid in a stabiliser vessel, i.e. the processing liquid in the stabiliser bath, is conveyed cocurrently with respect to the film, for better stabilising efficiency.

According to another aspect of the invention, the device for processing photographic material, e.g. undeveloped photosensitive film, comprises a sequence of consecutive processing vessels, each of said processing vessels having an entrance portion and an exit portion, and at least one of them having a low volume processing and transport channel in between, said processing and transport channel(s) being connected to a processing liquid replenishment portion and a withdrawal portion for replenishing and withdrawing said processing liquid, wherein transport means are assigned to the processing vessel having said low volume processing and transport channel, said transport means being arranged outside of the processing volume, so that there is no contact with the processing liquid, wherein cleaning means are arranged to clean the transport means. Since, according to this aspect of the invention the transport means, for instance pairs of rollers, are arranged outside of the processing volume and thus outside of the processing bath, processing bath ingredient can crystallise on the transport means and dirt particles can accumulate thereon, it is necessary to clean the transport means, because dirt and/or crystallised ingredients, of the processing liquid could otherwise damage the photographic material and in particular the emulsion side of the photographic material.

Accordingly, cleaning means clean the transport means, in particular after the device has stood idle. In accordance with the invention, for instance, the cleaning means can supply only a few drops of distilled water or the like, to dissolve crystallised ingredients of the processing liquid and rinse away dirt particles so that the transport means are clean and cannot scratch the photosensitive film and, generally speaking, the photographic material to be processed. It is sufficient to supply only a few drops of cleaning liquid and to withdraw the used cleaning liquid either by sucking off the cleaning liquid or by evaporating the cleaning liquid. Of course, it is also possible to use a blade or the like to scrape any particles from the transport means.

The cleaning of the transport means is particularly useful or necessary if, after a long period of time idle, photographic material has to be processed. Accordingly, sensor means should be provided near the entrance portion of a first processing vessel of the processing and transport channel, to activate the cleaning means. Accordingly, when photographic material approaches the processor in accordance with the invention, the cleaning means are activated and spray cleaning liquid onto the transport means, so that crystallised ingredients of the processing liquid can be dissolved and dirt can be rinsed from the surface of the transport means, in particular a pair of transport rollers.

Instead of transport rollers it is also possible for instance to use transport webs, or in the case of photosensitive film, sprockets, engaging into the transport perforations along both sides of the photographic film.

According to another aspect of the invention, a process for processing photographic material is proposed, wherein the photographic material is introduced into consecutive processing baths, comprising the steps that an exposed photographic material web enters a first processing bath included in a low volume processing and transport channel, and a developer solution in said first bath is conveyed in a direction co-current with the transport direction of the photographic material web.

According to this aspect of the invention, it is advantageous to direct an emulsion side of the photographic material towards the developer solution being supplied to the bath. At least the developer solution should have a component of an incident angle which is directed towards the emulsion side of the photographic material.

During the process, and in particular during the developing process, the respective processing liquid is circulated. Preferably, the processing liquid, and in particular the developer are heated to be very close to a set temperature value.

In accordance with the above-described invention, it is possible to provide a small dimensioned processor for photographic material, and in particular for photosensitive films like APS films and 135 films.

### BRIEF DESCRIPTION OF THE DRAWINGS

FIG. 1 shows a longitudinal cross-section through a small dimensioned film processor;

FIG. 2 shows a longitudinal cross-section through a module of a preferred embodiment of a film processor comparable to that in FIG. 1;

FIG. 3 shows a cross section through a recycle and recovery portion of the processor module in FIG. 2;

FIG. 4 shows a replenishment portion of the processor module in FIG. 2;

FIG. 5 shows a cross-section through a transport means for transporting photographic material;

FIG. 6 shows a cross-section through a processing and transport channel;

FIG. 7 shows a cartridge for fresh and exhausted processing liquid, in an upper plain view;

FIG. 8 shows the cartridge in FIG. 7 in a cross sectional view;

FIG. 9 shows the cartridge in FIG. 7 in a longitudinal cross sectional view; and

FIG. 10 shows a principal flow scheme for processing liquids which could be used in the embodiment according to FIG. 1.

### DETAILED DESCRIPTION OF THE PREFERRED EMBODIMENTS

In the figs., identical or comparable parts or items are referred to by means of the same reference numbers. A repeated description of parts can therefore be avoided to some extent.

While the present invention is explained with respect to a processor for processing photosensitive film, the same principle can also be applied to processors for processing exposed but undeveloped photographic print paper.

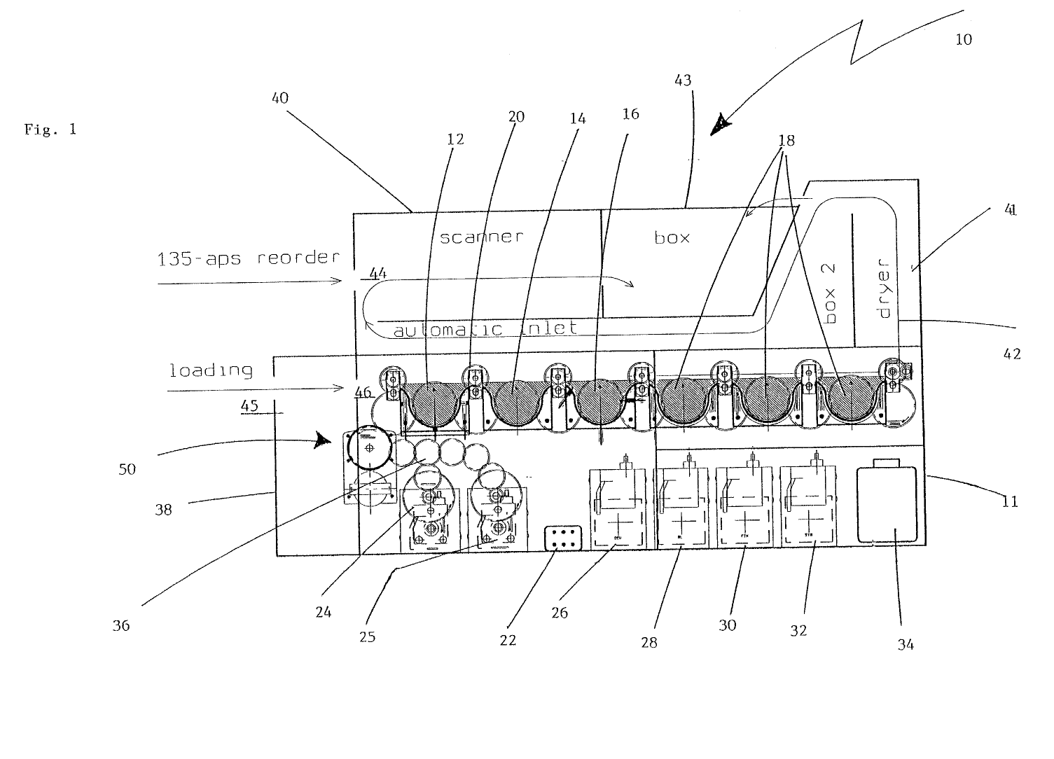

In FIG. 1 a preferred embodiment of a device with features in accordance with the invention is referred to by the reference number 10.

The device 10 includes a film processor, and a film scanner 40 with a film storage 43.

The scanner 40 has a re-order entrance 44 which can be used to enter and scan already developed films. The scanner can of course be used for 135 films and APS films.

The film processor 11 includes a load entrance 45 for supplying cartridges with exposed photosensitive films to be entered into the wet-part of the processor 11. Of course, it is also possible to enter large rolls of films spliced together for processing. Accordingly, the entrance 45 can be a part of an entrance compartment 38 for different purposes, for instance for connecting film cartridges light tight to the wet part of the processor 11, to be supplied to a secondary entrance 46 and processed in the wet part of the processor 11.

The film processor 11 includes several processing vessels 12, 14, 16, 18 which are arranged in a consecutive row. Between the consecutive processing vessels 12, 14, 16, 18 several transport means 20 are provided. In the present case, the transport means 20 are formed by means of pairs of transport rollers 20 which will be described in more detail with respect to a particular embodiment, later. The transport means 20 are driven by one or more electric motors 50, and the driving force is transmitted to the transport means 20 through a gear arrangement 36. It is also possible to use a gear arrangement between consecutive transport means 20. On the other hand, it is also possible to use a belt drive or a chain drive. It is of particular importance to convey the film through the different vessels or channels without any significant slippage, not to damage the film or to put any strain on the film.

The first processing vessel 12 is directed to the developing process. The second processing vessel 14 is directed to a bleaching process and the third processing vessel 16 relates to a fixing process. The last three processing vessels 18 are involved in a stabilising process. At the exit position of the wet-part, the film 42 is directed to a drier portion 41 where the developed film is dried, before being directed to the scanner 40.

The film processor 11 includes a heater arrangement 22, and the processing liquid in the processing vessels 12, 14, 16, 18 is pumped through the heater arrangement 22 to be adjusted to a particular pre-set temperature.

As can be seen, the transport means 20 are located outside of the vessels 12, 14, 16 and 18 and accordingly, the transport means are kept dry and any liquid arriving at the transport means can only do so because the liquid adheres to the surface of the photosensitive film.

In the present case, all of the processing vessels 12, 14, 16, 18 have a low volume processing and transport channel through which the films to be developed, bleached, fixed and stabilised are transported and in which they are processed. The level of the processing liquid in all the different channels, which will be described in detail later, is adjusted so that the liquid can be kept in the channels and so that the length of the processing and transportation channels remains the same so that the processing time can be kept constant.

By means of a comparatively aggressive and reactive developer, for instance C41 type chemistry, it is possible to use a very low volume developer bath with about 10 to 20 ml of active volume in contact with the surface of the photosensitive film to be processed. The processing time in each of the different processing baths amounts—depending on the type of chemistry—to about 45 to 50 sec., which is an example for C41 type chemistry. Accordingly, if it is possible to provide sufficient time to the developing process, it is possible to construct all the processing and transport channels, i.e. the processing vessels, with very small dimensions. If a faster processing time is intended, the length of the processing and transport channels have to be increased. In general, the longitudinal cross-section of the channels have a U-shape, so that it is possible to concentrate a long channel in a very small volume. The shape and the particular features of each of the vessels 12, 14, 16, 18 will be described in more detail below.

At the beginning of the consecutive row of processing vessels, there is a sensor means (not shown) which provides an electric control signal if a film web or a film strip is approaching the row of the vessels. If the sensor means detects an incoming film strip, the processing liquid in the processing and transport channels 13 is recycled, to warm up the processing liquid to the pre-set temperature value. Correspondingly, at the end of the row of consecutive processing vessels, there can also be provided a sensor means which detects the end of the last film introduced into the processor 11, in which case the recycling and the heating of the processing liquid is stopped to save energy, to avoid evaporation of processing liquid, and so on.

Since it is possible that a film processor is not used over a long period of time, it is necessary to clean and soften the transport means, e.g. pairs of transport rollers in the present case. Therefore, each of the pairs of transport rollers is provided with a cleaning means, for instance a kind of spraying apparatus, or a blade or the like, to clean the surface of the transport rollers, so that damaging or scratching of the emulsion side of the film strip can be avoided. Accordingly, after a particular pre-set time period has lapsed during which no processing has occurred, cleaning liquid can be dripped or sprayed onto the pairs of rollers, and the used cleaning liquid can be pumped off or evaporated. Since it is only necessary to supply a few drops of cleaning liquid, for instance distilled water, the used cleaning liquid can easily be evaporated.

At the bottom of the processor 11, a number of pumps are provided for the different processing liquids. These pumps 26, 28, 30, 32 are replenishing fresh processing liquids are stored which can be recycled in the recycle cycles, where the processing liquids are adjusted to a particular processing temperature. A recovery tank, which will be shown later, is arranged, and exhausted processing liquid can be conveyed from the processing vessels, i.e. the processing and transporting channels, to the recovery tank. A tank 34 includes cleaning liquid, e.g. distilled water, to be supplied to the transport means 20 for cleaning purposes.

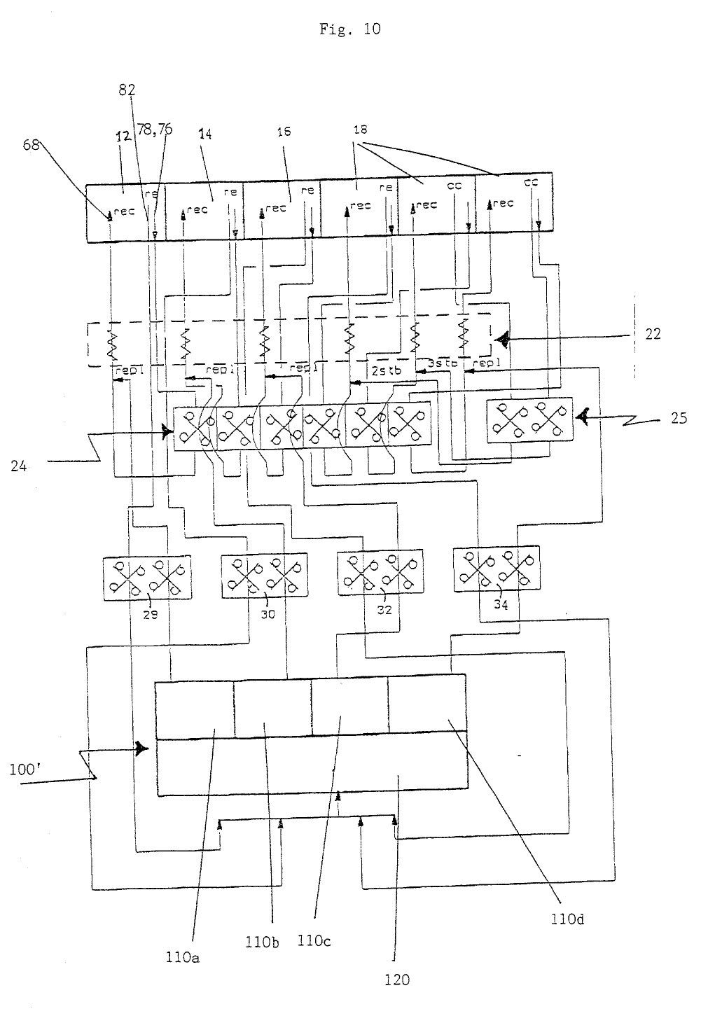

As will be described in detail below also with reference to FIG. 10, the processing liquid in the processing vessels 12, 14, 16, 18 are conveyed in the same direction as the photosensitive film to be processed.

The device 10 according to FIG. 1 can also be used by means of a process which can be described as follows: first, a film strip is entered through the entrance 46. A sensor means (not shown) detects that a film strip is approaching the first pair of transport rollers 20 in front of the entrance portion of the first processing vessel 12. If the device 11 is idle for a significant time period, a cleaning liquid is supplied to the first and also to other pairs of transport rollers 20, and the transport rollers are cleaned so that the film strip and in particular the emulsion side of the film strip cannot be damaged by dirt, crystallised ingredients of the processing liquids, or the like. When an approaching film strip has been detected, recycling of the developer bath, and immediately or subsequents of all of the other baths, can be started in order to adjust the temperature of the developer baths and also of the other processing baths to the set processing temperatures. Exhausted processing liquid can be replaced and the exhausted processing liquid can be withdrawn into a recovery tank. The replacement processing liquid can be pumped by means of pumps 26, 28, 30, 32 into the processing bath, i.e. into the recycle cycles and therefore into the processing and transport channels 64.

The pump means can be a low power and low volume type pump, for instance a peristaltic pump.

In the processing and transport channels 64 of the six first processing vessels 12, 14, 16, 18 the processing liquids are conveyed in the same direction as the film itself. The processing liquids are conveyed starting from a location near the entrance portion, through which the film strip enters a respective processing and transport channel.

Also in the last three processing channels of the last three processing vessels 18 the processing liquid is conveyed co-currently with respect to the film strip.

One embodiment of a flow scheme which is in accordance with the invention will now be described with reference to FIG. 10.

The consecutive row of processing vessels 12, 14, 16, 18 is connected to a variety of pump means 24,25,28,30,32,34 on several tanks 110a, 110b, 110c, 100d with fresh processing liquids and a tank 120′, all tanks being provided in a container 100′ for exhausted processing liquid.

The pump blocks 28, 30, 32, 34 are each comprised of a replenishment pump for fresh processing liquids and a withdrawal pump for exhausted processing liquid. Accordingly, all the pumps on the left-hand sides of the blocks 28, 30, 32, 34 are connected via connection pipes or tubes to the tank 120′ for exhausted processing liquid. All the pumps on the right-hand sides of the blocks 28, 30, 32,34 are connected via pipes or the like to the tanks 110a, 110b, 110c, 110d for fresh processing liquids. The tank 110a contains developer solution, the tank 110b bleacher solution, the tank 110c fixer solution and the tank 100c stabiliser solution. The container 110′ can be constructed like the container 100 shown in FIGS. 7 to 9.

The individual pumps of the pump block 24 are connected to withdrawal portions 74a, 76, 78 in FIGS. 3 and 4 of all of the different processing vessels 12, 14, 16, 18 to recycle the processing liquid to be kept on moving for good processing efficiency and to be reheated in a heater block 22 to keep the processing liquid at a constant processing temperature. The pumps of the pump block 25 are used for pumping the processing liquid, a stabiliser solution in this case, from the third stabiliser vessel, the last processing vessel in this row, to the second, and from the second to the first stabiliser vessel 18. Fresh stabiliser is only introduced into the third stabiliser vessel 18, which then can also be exhausted in the two stabiliser vessels 18 arranged in front of two stabiliser vessels. This provides an extended processing channel, while the constructive features of the processing vessels can be kept the same for all of the processing vessels 12, 14, 16, 18. Exhausted stabiliser solution is only withdrawn from the first of the three stabiliser vessels 18 (through withdrawal orifice 82, FIG. 3) to be pumped into the tank 120′. The fresh processing liquids are supplied to the recycle cycles before the liquids are arriving in the processing vessels with the predetermined processing temperature(s).

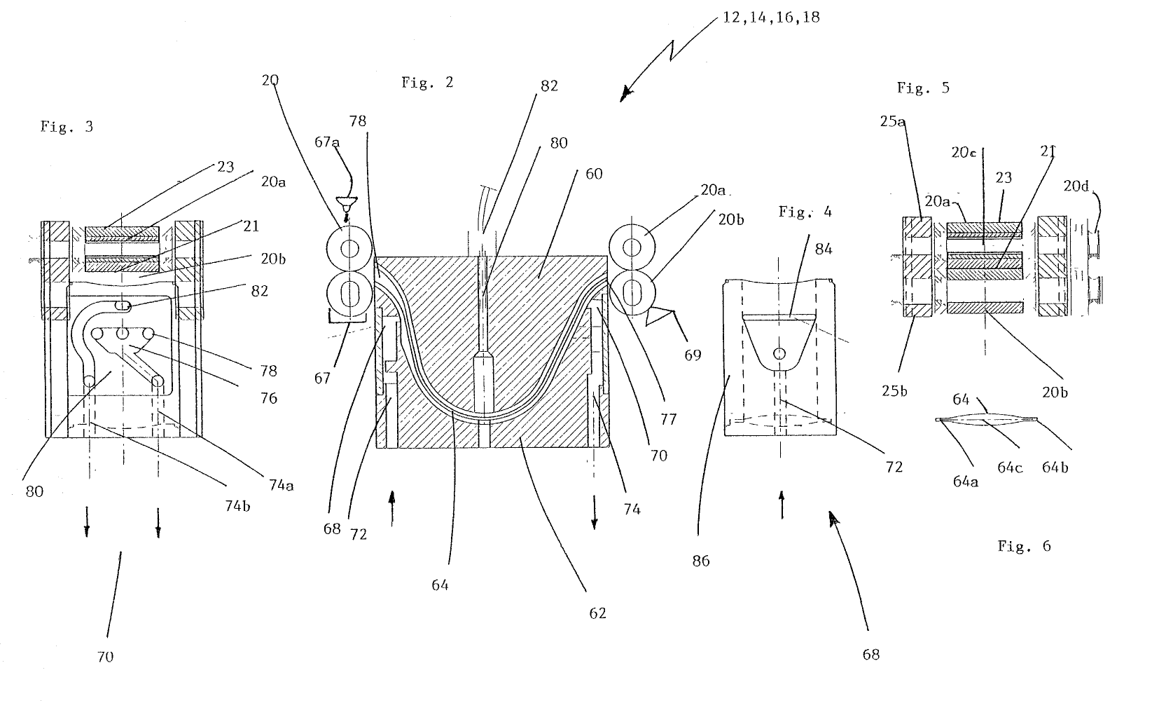

It is preferred to start and continue the recycling, replenishment and withdrawal operations in the vessels 12, 14, 16, 18 only when a film approaches a processing vessel and during the film is conveyed through its processing and transport channel (64 in FIG. 2). When the film has left the processing and transport channel of a processing vessel 12, 14, 16, 18, all pumps acting on the respective vessel can be deactivated. This saves processing liquid. The control of the activation and deactivation can be accomplished by a timer circuit of a known layout, taking into account the length of the film web which has to pass the corresponding processing and transport vessels. The length of the film web can be detected by the signal of a detector, e.g. a photoelectric detector, which detects the beginning and the end of a film web.

The replenishment of fresh processing liquid can be controlled, e.g., on the basis of the amount of processed film web, the length of which can be counted continuously by means of above-referred detector (not shown).

Now, with reference to FIG. 2, one processing vessel or processing unit shall be described in detail. In principle, each of the processing vessels 12, 14, 16, 18 can be constructed as shown in FIG. 2. Each of the processing vessels 12, 14, 16, 18 can be formed modularly. This means that each of the processing vessels 12, 14, 16, 18 can be replaced by another unit of the same type and construction.

Each of the processing units 12, 14, 16, 18 is comprised of an upper portion 60 and a lower portion 62 and between these two portions 60, 62 a low volume processing and transport channel 64 is formed. Accordingly, the upper border plane of the channel 64 is formed by the bottom end of the portion 60 and the lower boarder plane of the channel 64 is formed by the upper part of the lower portion 62.

An entrance 78 is arranged in the film transport direction at the beginning of the channel 64. The entrance is funnel-shaped to render the introduction of the film strip more easy. The pair of rollers 20 at the entrance 78 is provided with a cleaning means 67a, 67. Cleaning liquid, for instance drops of distilled water, can be supplied or sprayed onto the surface of the rollers via a pipe mouth 67a. The cleaning liquid then can be conveyed either by gravity or by rotation of the rollers, or both, towards the lower roller of the pair of rollers 20 in order to clean this roller as well. Afterwards, the exhausted cleaning liquid can drip into a collecting vessel 67, to be withdrawn by a pump means or to be evaporated by a heater or the like.

Another example of a cleaning means 69 is depicted in relation to the pair of transport rollers 20a, 20b at the exit portion 77 of the processing unit 12, 14, 16, 18 according to FIG. 2. While the pair of transport rollers 20a, 20b located at an exit portion 76 of the processing units 12, 14, 16, 18 is formed like the pair of rollers at the entrance portion 78, the cleaning portion 69 is formed as a kind of blade in order to scrape dust, dirt or the like from the surface of one of the rollers. Of course, a corresponding blade 69 can also be mounted in relation to the roller 20a. The particular shape and function of a preferred embodiment of the rollers 20a, 20b will be described below with reference to FIG. 5.

Near the entrance portion 77, a replenishment portion is provided through which it is possible to fill the processing and transport channel 64 with recycled and/or fresh processing liquid. The processing liquid arrives at the replenishment portion 68 through a pipe 72 which is connected to a recycle pipe arrangement and a replenishment pipe arrangement. The portion 68 will be described below with reference to FIG. 4.

Near the exit portion 76, a withdrawal portion 70 is provided which has the function of withdrawing the processing liquid to be recycled and reheated and, if necessary, refreshed. Furthermore, the withdrawal portion 70 includes a recovery portion through which exhausted processing liquid is withdrawn to be directed to a recovery tank (120, FIG. 7) for disposal purposes. The withdrawal portion 70 will be described in more detail with reference to FIG. 3.

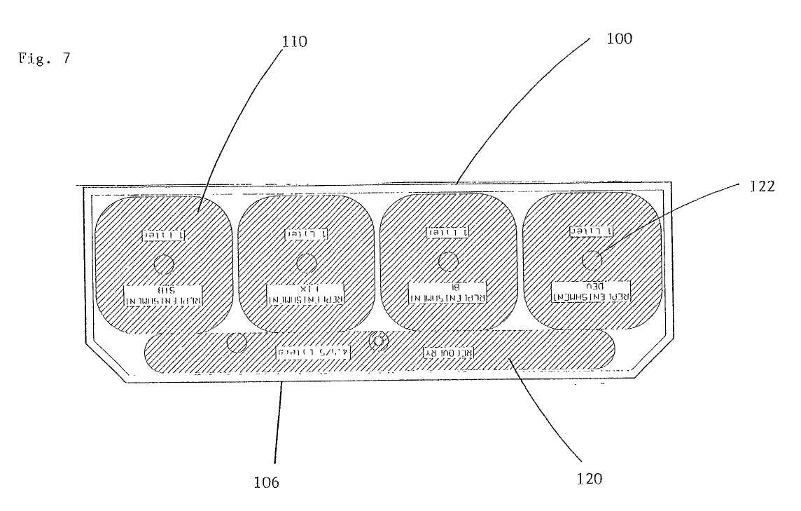

As shown in FIG. 6, the processing and transport channel 64 has, in cross section a disk-like shape. This shape is very narrow at the ends 64a, 64b of the channel 64 which narrow ends 64a, 64b are working as a guide for the film strip. Towards the middle of the channel 64, the cross section becomes broader so that the processing liquid has free access to the surface of the film strip and in particular to the surface of the emulsion side of the film strip. Furthermore, the shape of the channel 64 depicted in FIG. 6 avoids that the emulsion side can contact the walls of the channel 64, which could damage the film strip, e.g. scratch the emulsion side of the film strip.

Of course, other cross sectional shapes of the channel 64 can also be used. In accordance with the invention, it has proved advantageous to use the end sections as guide means, while the region between these end sections 64a, 64b issued for the process itself. Of course, if it is necessary in the case of APS films to fix a leader card to a film strip, the cross-section of the channel has to be modified, e.g. the narrow end sections 64a, 64b extend more to the left and right, respectively.

In FIG. 2, a tube-like shape 80 is machined into at least one of the portions 60, 62 of the processing vessel of the processing units 12, 14, 16, 18. A level sensor 82 is installed in the tube 80 and, if it senses that the level of the processing bath is too low, fresh processing liquid can be added to the recycling cycle and thus to the channel 64.

If the units 12, 14, 16, 18 or the complete processor device according to FIG. 1, has been under maintenance or under repair or is being activated for the first time, it is of course also possible to use the level sensor 82 as a means for adjusting the level of the processing liquid for the first time. Of course, the level sensor can also be placed elsewhere, for instance in either the replenishment portion 68 or the withdrawal portion 70.

In FIG. 3, the withdrawal portion 70 is depicted together with the pair of transport rollers 20a, 20b behind it. The withdrawal portion 70 is connected to a recycle pipe arrangement 74a and to a recovery pipe arrangement 74b. Processing liquid is withdrawn through an opening 78 and through a gathering portion 76, to be reheated in the heater 22 according to FIG. 1. Afterwards, the reheated and, if necessary, refreshed processing liquid can be supplied to the processing and transport channel 64 through the replenishment portion 68.

Above the level of the opening 78 of the withdrawal portion, a recovery opening 82 is provided for withdrawing exhausted processing liquid through the pipe arrangement 74b which is connected to a disposal tank, in order to expel the exhausted processing liquid from the process.

Furthermore, as shown in FIG. 3, the pair of transport rollers 20a, 20b is comprised of a transport roller 20b having a smooth and rigid surface and of a roller 20a, preferably a squeeze roller having a softer outer layer 23 which should help to transport the film without slipping and which should also help to restrict the pressure acting on the film. The film is transported through a nip 21 between the rollers 20b, 20a.

According to FIG. 4, the replenishment portion 68 comprises a slit-like exit 84 through which the recycled processing liquid is directed towards the emulsion side of the photographic material to be processed. The processing liquid is supplied to the slit 84 through a conduit or pipe 72. Of course, the slit 84 can be replaced by a row of small orifices or the like. The particular shape is not important while it is important to supply the processing liquid even and wall-balanced to each square unit of the emulsion side of the photographic film. The same applies to the orifices or openings 82 and 78, while it is not important here to provide an even, well-balanced withdrawal of the processing liquids.

With reference to FIG. 5, the construction as well as the driving arrangement of the roller pair shall be examined in more detail. The pair of rollers 20a, 20b can be called a squeegee arrangement. According to this squeegee arrangement, the roller 20a includes a soft rubber layer 23 which is supported by an axis 20c. The surface of the soft rubber layer can be porous, which may also help to take care of the photographic material to be processed. The photographic material is transported through the nip region 21. The surface as well as the material of the lower roller 20b is rigid but smooth. The two rollers are mechanically locked to each other by means of gears 25a, 25b, the sprockets of which engage with each other, such that the rotation of the two both rollers is locked with respect to each other. Furthermore, all the other transport means, in particular pairs of transport roller, shown in FIG. 1 are also mechanically locked to each other by means of gears or other sensible means. In principle all the transport means 20, 20a, 23b can be accomplished and work to same way.

The two rollers 20a, 20b are provided with additional support rims 20d. Spring means are provided (not depicted) which are slidingly held in the rims 20d so that a pressing force acting between the two rollers 20a, 20b can on the one hand be provided and, on the other hand, can be restricted to the force of the closed-loop spring.

FIG. 7 shows a cartridge 100 or container for fresh processing liquid and for exhausted processing liquid. The cartridge 100 comprises a rigid outer casing 106 and several collapsible containers 110, 120. The collapsible containers 110, 120 can be connected through connection means 122 to the conduits or pipes to and/or from the different vessels and their processing and transport channels 64.

According to the example shown in FIG. 7, the cartridge 100 includes four collapsible tanks for fresh developer, bleacher, fixing liquid and stabiliser liquid. Furthermore, an additional collapsible tank 120 is covered by the rigid outer wall 106 of the cartridge 100, said tank 120 being for the recovery of exhausted processing liquid.

The connection of the different tanks to their respective recycling cycles and processing and transport channels can be accomplished through injection connections with injection needles, through bayonet or twist lock connections, screw connections or comparable means.

It has to be taken into account that the cartridge 100 or container of the present invention enable a very limited space to be used for the fresh and the exhausted processing liquid, since when the fresh processing liquid is increasingly consumed, the collapsible tanks 110 collapse and, at the same time the recovery tank 120 is increasingly expanded into the free volume which was previously occupied by the collapsible containers 110.

One or all of the different tanks 110, 120 can be provided with a level sensor to sense the amount of processing liquid whether exhausted or not in the respective tanks. On the other hand, in order to be aware of the remainder or the rest of fresh processing liquid, it is also possible to provide a kind of renewal sensor means which, when the cartridge 100 is replaced, sends a control signal to an electronic circuit which then can calculate for how long the fresh processing liquid in the collapsible tanks 110 will be enough to guarantee an unaffected operation. This calculation can be done using different parameters like the length of the processed photographic material, the elapsed time after the last cartridge replacement, and so on.

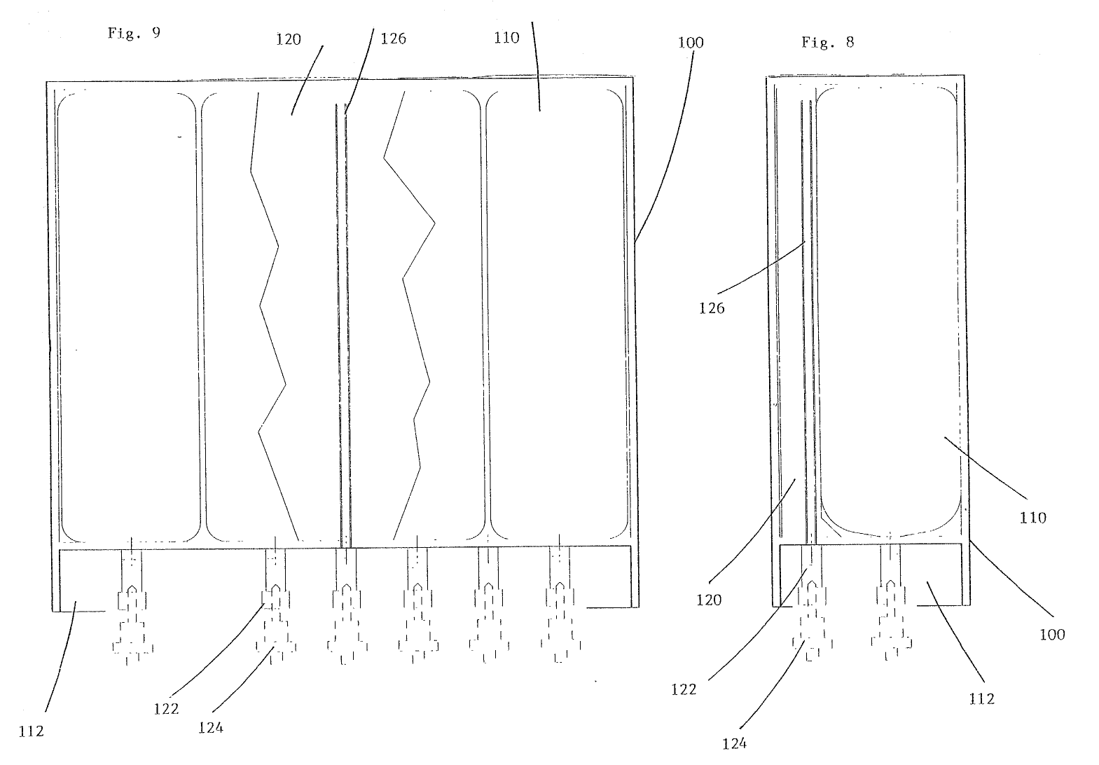

In FIGS. 8 and 9, the container according to FIG. 7 is shown in different cross sections. According to FIGS. 8 and 9, the connection between the collapsible tanks and the respective pipe systems is accomplished at the lower end of the container 100 by means of injections needles. The injection arrangements 124 penetrate through rubber plugs in the mouth areas 122 of the collapsible tanks 110. The same connection arrangement is used with the recovery or overflow tank 120.

According to this aspect of the invention, the cartridge 100 only needs one space for the fresh processing liquid as well as for the exhausted processing liquid.

1. A device for processing photographic material, e.g. undeveloped photosensitive film, comprising:
a) a sequence of consecutive processing vessels;
b) each of said processing vessels having an entrance portion and an exit portion and at least one of them having a low volume processing and transport channel in between;
c) said processing and transport channel being connected to a processing liquid replenishment portion and a withdrawal portion, for replenishing and withdrawing the processing liquid, wherein
d) the replenishment portion is arranged near the entrance portion of the processing and transport channel; and
e) the withdrawal portion is arranged near the exit portion of the processing and transport channel,
f) such that a level of the processing liquid in the processing and transport channel is maintained within the processing and transport channel.

2. A device according to claim 1, wherein transport means for transporting the photographic material are arranged at least on either the side of the entrance or the side of the exit portion, such that said transport means are essentially not in contact with the processing liquid in the processing and transport channel.

3. A device according to claim 1, wherein transport means are provided for transporting the photographic material at least on either the side of the entrance or the side of the exit portion, and wherein said transport means are provided with cleaning means for cleaning the transport means.

4. A device according to claim 1, wherein a re-circulation cycle is provided for at least one of the processing and transport channels, said re-circulation cycle including a heater for regulating the temperature of the processing liquid.

5. A device according to claim 4, wherein a temperature sensor is provided for measuring the temperature of the processor liquid to compensate for deviations from a set optimised temperature value correspondingly by controlling the heater.

6. A device according to claim 1, wherein a vessel is a developer vessel, to whose processing and transport channel a processing liquid conveying means is connected to convey the processing liquid in the direction co-current with a transport direction of a photographic material.

7. A device according to claim 1, wherein the consecutive vessels comprise a developer vessel a bleaching vessel; a fixing vessel; and at least one stabiliser vessel; wherein at least in the three first vessels, the processing liquids are transported co-currently.

8. A device according to claim 1, wherein the processing liquid is directed from the replenishment portion towards an emulsion side of the photographic material.

9. A device according to claim 1, wherein the withdrawal portion comprises a recovery outlet, to expel exhausted processing liquid.

10. A device according to claim 1, wherein a sensor means is arranged near the entrance portion of the first processing vessel and/or near the exit portion of the last processing vessel, to start and/or stop the re-circulating of processing liquid when an approaching or departing end of a photographic material is detected.

11. A device according to claim 10, wherein a timer device is arranged to control replenishment, withdrawal and/or re-circulation of a processing liquid in a processing vessel in relation to a predetermined time period which is necessary for the photographic material to pass at least its processing and transport channel.

12. A device according to claim 2 or 3, wherein the transport means are formed with a pair of two roller-like means, wherein the one roller of said pair has a rigid and smooth surface directed towards the emulsion side of the photographic material, and the other of the pair is soft, said pair forming a nip, and the photographic material being conveyed through said nip.

13. A device for processing photographic material, e.g. undeveloped photosensitive film, comprising:
a) a sequence of consecutive processing vessels;
b) each of said processing vessels having an entrance portion and an exit portion and at least one of them having a low volume processing and transport channel in between;
c) said processing and transport channel being connected to a processing liquid replenishment portion and a withdrawal portion, for replenishing and withdrawing the processing liquid, wherein
d) transport means are assigned to the processing vessel having said low volume processing and transport channel, said transport means being arranged outside the processing volume so that there is no contact with the processing liquid;
e) wherein cleaning means are arranged, having cleaning access to the transport means.

14. A device according to claim 12, wherein cleaning supply means are provided for supplying cleaning liquid to said transport means.

15. A device according to claim 12 or 13, wherein collection means are assigned to the transport means so that used cleaning liquid and/or dirt coming from the transport means are collected, to be withdrawn or evaporated.

16. A device according to one of claims 12 to 14, wherein sensor means are provided near the entrance portion of a first processing vessel, to activate the cleaning means at least after a given ideal time period has expired.

17. A process for processing photographic material, wherein photographic material is introduced into consecutive processing baths, comprising the steps an exposed photographic material enters a first processing bath included in a low volume processing and transport channel; wherein
a developer solution in said first bath is conveyed in the direction co-current with the transport direction of the photographic material.

18. A process according to claim 16, wherein an emulsion side of a photographic material is arranged such that said developer solution being supplied to the bath has an incident angle with respect to the emulsion side, and in particular is directed towards the emulsion side.

19. A process according to claim 16, wherein processing liquid in a respective processing bath is circulated if the photographic material enters the bath and during transportation of the photographic material to the bath.

20. A process according to claim 16, wherein the temperature of a developer bath is controlled to be stable within an interval of 0.5° C. and in particular ±0.3° C. around a target temperature.

21. A process according to claim 16, wherein the consecutive processing baths comprise a bleaching, a fixing and a stabilising bath, wherein respective processing liquids in the bleaching, fixing and stabilising bath are moved co-currently with the photographic material.

22. A process according to claim 16, wherein the circulation of the processing liquid in a processing bath is stopped if the end of the photographic material has been detected leaving the bath.

23. A process according to claim 16, wherein, if a photographic material approaches a first processing bath and a pre-set time period has elapsed, transport means for transporting the photographic material are cleaned and/or wetted.
